(19) United States
(12) Patent Application Publication
(10) Pub. No.: US 2025/0112517 A1
(43) Pub. Date: Apr. 3, 2025

(54) STATOR, MOTOR, AND DRONE

(71) Applicant: NIDEC CORPORATION, Kyoto (JP)

(72) Inventors: Yoshitsugu SASAGURI, Kyoto (JP); Kosuke NIIMI, Kyoto (JP); Shintaro SAEKI, Kyoto (JP); Maho HOTTA, Kyoto (JP); Hiroaki AKAZAKI, Kyoto (JP)

(21) Appl. No.: 18/897,195

(22) Filed: Sep. 26, 2024

(30) Foreign Application Priority Data
Sep. 28, 2023 (JP) 2023-166803

(51) Int. Cl. H02K 3/50; B64U 50/19

(52) U.S. Cl. CPC H02K 3/50; B64U 50/19; H02K 2203/06

(57) ABSTRACT

A stator of a multi-phase motor includes a lead-out portion including one or more adjacent slots. A winding is divided into phase windings corresponding to multiple phases. Each of the phase windings includes winding portions wound around a tooth, a connecting wire connecting the winding portions, and a starting end portion and a terminating end portion where both terminals of the phase winding are led out. At least one of the phase windings includes a first winding portion wound around the tooth farther on one side in a circumferential direction than the lead-out portion, a second winding portion wound around the tooth farther on another side in the circumferential direction than the lead-out portion, and a first connecting wire connecting the first winding portion and the second winding portion on one side in an axial direction of the lead-out portion.

### CROSS-REFERENCE TO RELATED APPLICATIONS

The present application claims priority under 35 U.S.C. § 119 to Japanese Patent Application No. 2023-166803, filed on Sep. 28, 2023, the entire contents of which are hereby incorporated herein by reference.

### 1. Field of the Invention

The present disclosure relates to stators, motors, and drones.

### 2. Background

A conventional stator is known. This stator is a stator of a motor of multiple phases in which a winding is wound around a stator core, and includes an annular core back, a plurality of teeth extending in a radial direction from the core back and arranged in a circumferential direction, and a slot formed between adjacent ones of the teeth. The winding is divided into phase windings corresponding to phases of multiple phases.

In the above-described conventional stator, in a case where a starting end portion and a terminating end portion of each of the phase windings are collectively led out, for example, from an adjacent slot for the purpose of improving assemblability, there is a concern that a connecting wire connecting winding portions and a lead wire leading out a starting end portion and a terminating end portion become long particularly in a phase winding wound last. In a case where the connecting wire or the lead wire is long, not only workability is deteriorated since it is difficult to arrange the connecting wire or the lead wire, but also there is a concern that a space factor, which is a ratio of a winding portion to a slot, is reduced.

### SUMMARY

An example embodiment of a stator according to the present disclosure is a stator of a motor of multiple phases, and includes a lead-out portion including one or more adjacent slots. The winding is divided into phase windings corresponding to phases of the multiple phases. Each of the phase windings includes winding portions wound around a tooth, a connecting wire connecting the winding portions, and a starting end portion and a terminating end portion where two terminals of the phase winding are led out. A starting end portion and a terminating end portion of each of the phase windings are led out from any of the slots of the lead-out portion. At least one of the phase windings includes a first winding portion wound around one of the teeth farther on one side in a circumferential direction than the lead-out portion, a second winding portion wound around the one of the teeth farther on another side in the circumferential direction than the lead-out portion, and a first connecting wire connecting the first winding portion and the second winding portion on one side in an axial direction of the lead-out portion. At least a portion of the first connecting wire is arranged on the outer side in a radial direction of at least a portion of the starting end portion and the terminating end portion of each of the phase windings on one side in the axial direction of the lead-out portion.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is an explanatory view illustrating indication of a tooth and a slot in an explanatory view (FIG. 2) illustrating a winding pattern of a winding of a stator according to a first example embodiment of the present disclosure.

FIG. 2 is an explanatory view illustrating a winding pattern of a winding of the stator according to the first example embodiment of the present disclosure.

### DETAILED DESCRIPTION

Hereinafter, example embodiments of the present disclosure will be described with reference to the accompanying drawings. Note that, in the present description, a direction parallel to a central axis of a motor is referred to as an “axial direction”, a direction orthogonal to the central axis of the motor is referred to as a “radial direction”, and a direction along an arc around the central axis of the motor is referred to as a “circumferential direction”. In the drawings, the same or corresponding parts are denoted by the same reference numeral and description of such parts will not be repeated.

A drone has a propeller and a motor, and the motor rotates the propeller about a central axis. The motor includes a rotor and a stator, and the rotor includes a shaft, a rotor holder, and a rotor magnet. The shaft has a columnar shape forming a rotation axis extending along the central axis, and is rotatably supported around the central axis by a bearing. The rotor holder is fixed to the shaft and has a covered cylindrical shape, and the rotor magnet is fixed to an inner peripheral surface of the rotor holder and is arranged to face the radially outer side of the stator. When the motor is driven, torque is generated between the stator and the rotor magnet. Note that the rotor holder may include a lid-like hub fixed to the shaft and a cylindrical back iron extending in the axial direction in an outer edge portion in the radial direction of the hub. Further, the motor is an outer rotor type motor.

The stator is arranged so as to face the rotor in the radial direction. The stator is a stator of a motor of multiple phases in which a winding is wound around a stator core, and includes an annular core back, a plurality of teeth T extending in the radial direction from the core back and arranged in the circumferential direction, and a slot S formed between adjacent ones of the teeth T.

The core back is annularly formed around the central axis, and includes a stacked steel plate. The teeth T extend radially outward from the core back, and are arranged at equal intervals in the circumferential direction. By the above, a stator for an outer rotor type motor is formed.

A winding is divided into phase windings corresponding to phases of a motor of multiple phases, and each of the phase windings includes a plurality of winding portions wound around the tooth T, a connecting wire connecting the winding portions, and a starting end portion and a terminating end portion where both terminals of the phase winding are drawn.

In the winding portion, the phase winding is wound around the tooth T a plurality of turns, and a boundary between the winding portion and the connecting wire is as described below. In a first turn of winding of the phase winding around the tooth T, a portion where the phase winding protrudes in the axial direction from the slot S is a connecting wire, and a portion after a portion where the phase winding is arranged in the slot S is a winding portion. Further, in a last turn of winding of the phase winding around the tooth T, a portion up to a portion where the phase winding is arranged in the slot S is a winding portion, and a portion after a portion where the phase winding protrudes in the axial direction from the slot S is a connecting wire. In other words, a boundary between the winding portion and the connecting wire is defined by an end surface in the axial direction of the stator core. Here, it is interpreted that there is no connecting wire between winding portions where the phase windings are continuously wound around adjacent ones of the teeth T.

The stator further includes a lead-out portion L including one or a plurality of adjacent ones of the slots S, and a starting end portion and a terminating end portion of each phase winding are led out from any of the slots S of the lead-out portion L. Each phase winding includes a lead wire connecting a winding portion and a starting end portion, and a lead wire connecting a winding portion and a terminating end portion.

A boundary between a winding portion and a lead wire is as described below. In a first turn of winding of a phase winding around the tooth T, a portion where the phase winding protrudes in the axial direction from the slot S is a lead wire, and a portion after a portion where the phase winding is arranged in the slot S is a winding portion. Further, in a last turn of winding of the phase winding around the tooth T, a portion up to a portion where the phase winding is arranged in the slot S is a winding portion, and a portion after a portion where the phase winding protrudes in the axial direction from the slot S is a lead wire. In other words, a boundary between the winding portion and the lead wire is defined by an end surface in the axial direction of a stator core.

The connecting wire and the lead wire are arranged while slack is prevented by appropriately combining extending in the circumferential direction on one side in the axial direction of the stator core, extending in the axial direction in the slot S, and extending in the circumferential direction on another side in the axial direction of the stator core. In a case where the number of times the connecting wire and the lead wire extend in the axial direction in the slot S is large, the connecting wire and the lead wire become long, and thus, workability of manufacturing the stator is deteriorated, and a space factor, which is a ratio of the winding portion to the slot S, is deteriorated.

Since the lead-out portion L includes one slot or a plurality of adjacent ones of the slots S, windings led out from the stator can be collected. For this reason, routing for connecting a winding led out from the stator or a lead wire connected to a winding led out from the starter to another component such as a substrate is simplified, and workability is improved. For example, in a drone, an arm-shaped portion extends from a main body portion, and a propeller and a motor for driving the propeller are arranged at a tip portion of the arm-shaped portion. However, by collecting windings led out from the stator or lead wires connected to a winding led out from the starter, it is easy to incorporate a wiring in the arm-shaped portion.

On the other hand, in a case where the lead-out portion L includes one or a plurality of adjacent ones of the slots S, and a starting end portion and a terminating end portion of each phase winding are collectively led out, a circumferential width in which the connecting wire or the lead wire extends in the circumferential direction becomes long, the number of times the connecting wire or the lead wire extends in the axial direction in the slot S becomes large, and there is a concern that the connecting wire or the lead wire becomes long. In particular, in a case where a connecting wire or a lead wire is long in a phase winding wound last, it is difficult to arrange the connecting wire or the lead wire.

Hereinafter, a first example embodiment of the present disclosure in a stator of a three-phase motor having a U phase, a V phase, and a W phase will be described. Windings are divided into a first phase winding corresponding to the U phase, a second phase winding corresponding to the V phase, and a third phase winding corresponding to the W phase. However, the motor is not limited to a motor of three phases, and may be a motor of multiple phases other than three phases.

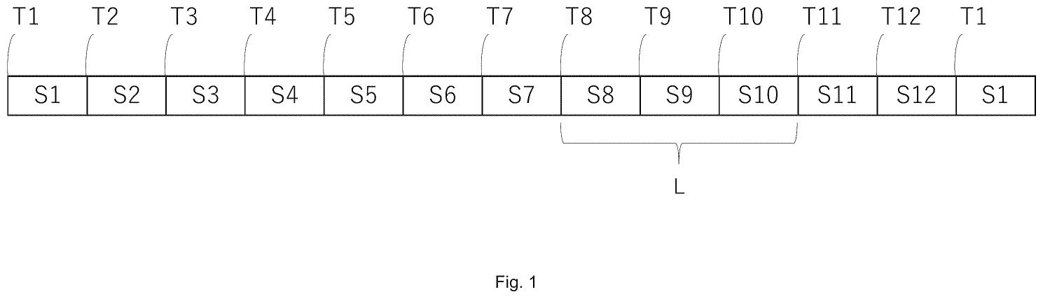

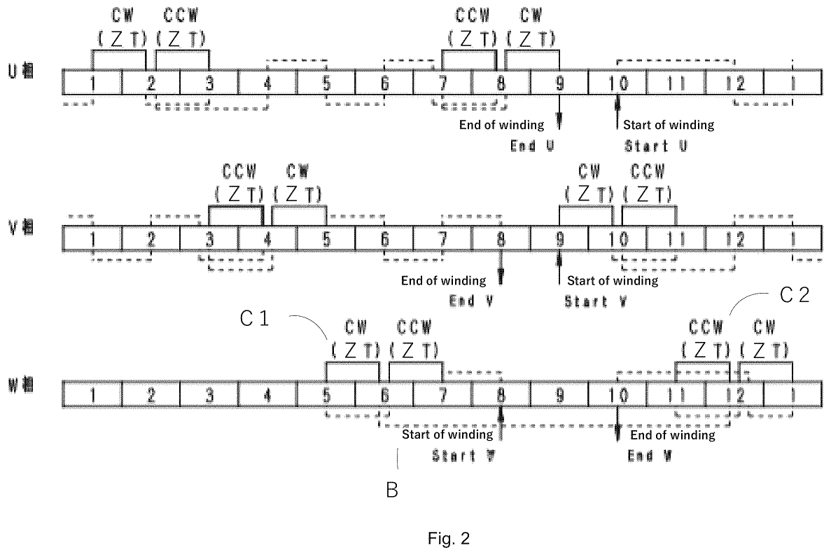

FIG. 1 is an explanatory view illustrating indication of the tooth T and the slot S in an explanatory view (FIG. 2) illustrating a winding pattern of a winding of a stator according to the first example embodiment of the present disclosure, and FIG. 2 is an explanatory view illustrating the winding pattern of the winding wire of the stator according to the first example embodiment of the present disclosure. FIGS. 1 and 2 illustrate a state in which a direction of the central axis is viewed from the outer side in the radial direction while teeth T1 to T12 arranged side by side in the circumferential direction are linearly developed. Slots S1 to S12 being a space are formed between adjacent ones of the teeth T1 to T12. For example, the slot S1 is formed between the teeth T1 and T2, the slot S2 is formed between the teeth T2 and T3, and the same applies to subsequent ones of the teeth T and slot S, and the slot S12 is formed between the teeth T12 and T1. Note that, in FIG. 1, the slots S1 to S12 are indicated by a rectangle with a reference numeral, and the teeth T1 to T2 are indicated by a side of a rectangles with a reference numeral. Further, in FIG. 2, for the sake of simplicity, rectangles with numbers corresponding to reference numerals of the slots S1 to S12 are illustrated for the purpose of indicating positions of the slot S and the tooth T, and illustration by a reference numeral of the tooth T is omitted.

Each phase winding is led out from the lead-out portion L to the one side in the axial direction (lower side in FIGS. 1 and 2) of a stator core. Further, for each of the teeth T, clockwise winding of a phase winding is indicated by CW (clockwise), and counterclockwise winding is indicated by CCW (counterclockwise) when viewed from the outer side in the radial direction.

The lead-out portion L includes three adjacent slots, the slot S8, the slot S9, and the slot S10. A starting end portion of a first phase winding is led out from the slot S10 and a terminating end portion of the first phase winding is led out from the slot S9. A starting end portion of a second phase winding is led out from slot S9 and a terminating end portion of the second phase winding is led out from slot S8. A starting end portion of a third phase winding is led out from slot S8 and a terminating end portion of the third phase winding is led out from slot S10. Here, for a phase winding of each phase, a winding start position and a winding end position may be interchanged, in other words, a starting end portion and a terminating end portion may be interchanged.

In the first example embodiment, the lead-out portion L includes a plurality of adjacent ones of the slots S, and a phase winding is led out from all the slots S of the lead-out portion L. However, the lead-out portion L may include one of the slot S, and may include the slot S from which a phase winding is not led out between the slots S from which a phase winding is led out.

In the first example embodiment, the stator is a stator of a motor of three phases in which three phase windings are connected by delta connection, and the lead-out portion L includes three adjacent ones of the slots S. The third phase winding includes a first winding portion C1 wound around the tooth T further on one side in the circumferential direction than the lead-out portion L, a second winding portion wound around the tooth T further on another side in the circumferential direction than the lead-out portion L, and a first connecting wire connecting the first winding portion C1 and the second winding portion C2 on one side in the axial direction of the lead-out portion L. Further, the third phase winding further includes a winding portion wound around the tooth T adjacent to the tooth T around which the first winding portion C1 is wound, and a winding portion wound around the tooth T adjacent to the tooth T around which the second winding portion C2 is wound. In this way, regarding the third phase winding, a circumferential width between a winding portion and the lead-out portion L can be made small, and the lead wire of the third phase winding can be shortened.

Each of a starting end portion and a terminating end portion of the third phase winding is led out one by one from one of two of the slots S on both sides in the circumferential direction in the lead-out portion L. Each of a starting end portion and a terminating end portion of the first phase winding is led out one by one from any of two of the slots S on another side in the circumferential direction of the lead-out portion L, and each of a starting end portion and a terminating end portion of the second phase winding is led out one by one from any of two of the slots S on one side in the circumferential direction of the lead-out portion L. This facilitates delta connection.

In the first phase winding corresponding to the U-phase, a starting end portion is led out from the slot S10 to one side in the axial direction of the stator core, and a lead wire extends in the axial direction in the slot S10 and extends in the circumferential direction from the slot S10 to the slot S12 on another side in the axial direction of the stator core. The lead wire extends in the axial direction in the slot S12, extends in the circumferential direction from the slot S12 to the slot S1 on one side in the axial direction of the stator core, and is connected to a winding portion around which the first phase winding is wound around the tooth T2. After a winding portion is formed by winding the first phase winding around the tooth T2 in a Z turn CW (clockwise) manner, a winding portion is formed by continuously winding the first phase winding around the tooth T3 in a Z turn CCW (counterclockwise) manner. Here, Z turn is the number of turns which is the number of turns in the winding portion, and the number Z of turns is a predetermined natural number. A connecting wire led out from the slot S2 extends in the circumferential direction to the slot S4 on one side in the axial direction of the stator core. The connecting wire extends in the axial direction in the slot S4, the slot S5, and the slot S6, extends in the circumferential direction from the slot S5 to the slot S6 on one side in the axial direction of the stator core, extends in the circumferential direction from the slot S4 to the slot S5 and from the slot S6 to the slot S7 on another side in the axial direction of the stator core, and is connected to a winding portion around which the first phase winding is wound around the tooth T8. After a winding portion is formed by winding the first phase winding around the tooth T8 in a Z turn CCW (counterclockwise) manner, a winding portion is formed by continuously winding the first phase winding around the tooth T9 in a Z turn CW (clockwise) manner. A terminating end portion of the first phase winding is led out from the slot S9 to one side in the axial direction of the stator core.

A starting end portion of the second phase winding associated with the V phase is led out from the slot S9 to one side in the axial direction of the stator core. After a winding portion is formed by winding the second phase winding around the tooth T10 in a Z turn CW (clockwise) manner, a winding portion is formed by continuously winding the second phase winding around the tooth T11 in a Z turn CCW (counterclockwise) manner. A connecting wire led out from the slot S10 extends in the circumferential direction to the slot S12 on one side in the axial direction of the stator core. The connecting wire extends in the axial direction in the slot S12, the slot S1, and the slot S2, extends in the circumferential direction from the slot S1 to the slot S2 on one side in the axial direction of the stator core, extends in the circumferential direction from the slot S12 to the slot S1 and from the slot S2 to the slot S3 on another side in the axial direction of the stator core, and is connected to a winding portion around which the second phase winding is wound around the tooth T4. After a winding portion is formed by winding the second phase winding around the tooth T4 in a Z turn CCW (counterclockwise) manner, a winding portion is formed by continuously winding the second phase winding around the tooth T5 in a Z turn CW (clockwise) manner. A lead wire led out from the slot S4 extends in the circumferential direction to the slot S6 on another side in the axial direction of the stator core. The lead wire extends in the axial direction in the slot S6, the slot S7, and the slot S8, extends in the circumferential direction from the slot S6 to the slot S7 on one side in the axial direction of the stator core, and extends in the circumferential direction from the slot S7 to the slot S8 on another side in the axial direction of the stator core. A terminating end portion of the second phase winding is led out from the slot S8 to one side in the axial direction of the stator core.

A starting end portion of the third phase winding associated with the W phase is led out from the slot S8 to one side in the axial direction of the stator core. The lead wire extends in the axial direction in the slot S8, extends in the circumferential direction from the slot S8 to the slot S6 on another side in the axial direction of the stator core, and is connected to a winding portion around which the third phase winding is wound around the tooth T7. After a winding portion is formed by winding the third phase winding around the tooth T7 in a Z turn CCW (counterclockwise) manner, a winding portion is formed by continuously winding the third phase winding around the tooth T6 in a Z turn CW (clockwise) manner. The connecting wire led out from the slot S6 extends in the circumferential direction in the slot S12 on one side in the axial direction of the stator core, and is connected to a winding portion around which the third phase winding is wound around the tooth T12. After a winding portion is formed by winding the third phase winding around the tooth T12 in a Z turn CCW (counterclockwise) manner, a winding portion is formed by continuously winding the third phase winding around the tooth T1 in a Z turn CW (clockwise) manner. A lead wire led out from the slot S12 extends in the circumferential direction in the slot S10 on another side in the axial direction of the stator core, and extends in the axial direction in the slot S10. The terminating end portion of the third phase winding is led out from the slot S10 to one side in the axial direction of the stator core.

Here, the third phase winding wound last includes the first winding portion C1 wound around the tooth T6 further on one side in the circumferential direction than the slot S8, the slot S9, and the slot S10 which are the lead-out portions L, and the second winding portion C2 wound around the tooth T12 further on another side in the circumferential direction than the lead-out portion L. Further, a first connecting wire B extending in the circumferential direction from the slot S6 to the slot S12 on one side in the axial direction of the data core and connecting the first winding portion C1 and the second winding portion C2 is included. Here, the first connecting wire B does not extend in the axial direction in the slot S, in other words, does not include a portion arranged on another side of the stator core, and extends in the circumferential direction from the slot S6 to the slot S12 on one side in the axial direction of the stator core.

By the above, a connecting wire and a lead wire can be shortened in the third phase winding. As a result, it is possible to easily arrange a connecting wire and a lead wire, improve workability of manufacturing a stator, and improve a space factor, which is a ratio of a winding portion to the slot S.

Here, at least a part of the first connecting wire B is arranged on the outer side in the radial direction of at least a part of a starting end portion and a terminating end portion of each of the first phase winding, the second phase winding, and the third phase winding on one side in the axial direction of the lead-out portion L. In this way, it is possible to prevent the first connecting wire B from being located on the inner side in the radial direction when extending in the circumferential direction from the slot S6 to the slot S12 on one side in the axial direction of the stator core. At this time, an exposed portion, which is a portion where a steel plate of a core back is exposed in the axial direction, can be secured on the inner side in the radial direction of the core back, and the stator core can be press-fitted into another component with high dimensional accuracy by pushing the exposed portion of the core back at the time of assembly. Further, on one side in the axial direction of the stator core, it is possible to prevent the first connecting wire B from being located further on the inner side in the radial direction than an insulating material arranged on a tooth, and as a result, it is possible to prevent occurrence of a withstand voltage defect.

As another example embodiment, all of a starting end portion and a terminating end portion of each of the first phase winding, the second phase winding, and the third phase winding are led out from the slot S of the lead-out portion L on the inner side in the radial direction of the first connecting wire B. In this way, it is possible to more reliably prevent the first connecting wire B from being located on the inner side in the radial direction when extending in the circumferential direction from the slot S6 to the slot S12 on one side in the axial direction of the stator core.

Although the case of the motor including 12 of the slots S is described above, in a case of a motor including N of the slots S, the slot S in which the first connecting wire B is connected to the second winding portion C2 is an M-th one of the slots S toward another side in the circumferential direction from the slot S in which the first winding portion C1 is connected to the first connecting wire B, and M is N/2 or more. For example, in a case of a motor including 24 of the slots S, the slot S in which the first connecting wire B is connected to the second winding portion C2 is 12th one of the slots S toward another side in the circumferential direction from the slot S in which the first winding portion C1 is connected to the first connecting wire B. Similarly to the case where the number of the slots S is 12 described above, in a case where the number of the slots S is 24, since the first connecting wire B is arranged on one side in the axial direction of the stator core over half the circumference, a connecting wire of a phase winding including the first connecting wire B can be shortened.

The motor includes the stator of the first example embodiment, and may further include a rotor that faces the stator in the radial direction and rotates about the central axis. At this time, workability of motor production can be improved, and power consumption of the motor can be reduced. The drone may include such a motor and further include a propeller fixed to the rotor and rotating around the central axis. At this time, workability of drone production can be improved, and power consumption of the drone can be reduced.

The example embodiments of the present disclosure are described above with reference to the drawings. However, the above example embodiments are merely exemplification of the present disclosure, and the present disclosure is not limited to the above example embodiments, and can be implemented in various aspects without departing from the gist of the present disclosure. For easy understanding, the drawings schematically illustrate each constituent element as the subject, and thickness, length, number, and the like of each illustrated constituent element are different from actual ones for convenience of drawing. Further, a material, shape, dimensions, and the like of each constituent element described in the above example embodiments are merely examples and are not particularly limited, and various modifications can be made without substantially departing from the effect of the present disclosure. Configurations of the example embodiments may be appropriately modified without departing from the technical idea of the present disclosure. Further, example embodiments may also be implemented in combination as far as possible.

Note that the present techniques can also use or embody various configurations as described below.
(1) A stator of a motor of multiple phases in which a winding is wound around a stator core, the stator including an annular core back, teeth extending in a radial direction from the core back and arranged in a circumferential direction, a slot between adjacent ones of the teeth, and a lead-out portion including one or a plurality of adjacent ones of the slots. The winding is divided into phase windings corresponding to individual phases of the multiple phases, each of the phase windings includes a plurality of winding portions wound around one of the teeth, a connecting wire connecting the winding portions, and a starting end portion and a terminating end portion where two terminals of the phase winding are led out, the starting end portion and the terminating end portion of each of the phase windings are led out from any of the slots of the lead-out portion, at least one of the phase windings includes a first winding portion wound around the one of the teeth farther on one side in the circumferential direction than the lead-out portion, a second winding portion wound around the one of the teeth farther on another side in the circumferential direction than the lead-out portion, and a first connecting wire connecting the first winding portion and the second winding portion on one side in an axial direction of the lead-out portion, and at least a portion of the first connecting wire is arranged on an outer side in the radial direction of at least a portion of the starting end portion and the terminating end portion of each of the phase windings on one side in the axial direction of the lead-out portion.
(2) The stator according to (1), in which all of the starting end portions and the terminating end portions of each of the phase windings are led out on an inner side in the radial direction of the first connecting wire.
(3) The stator according to (1) or (2), further including N slots, in which the slot in which the first connecting wire is connected to the second winding portion is an M-th slot toward another side in the circumferential direction from the slot in which the first winding portion is connected to the first connecting wire, and M is N/2 or more.
(4) The stator according to any of (1) to (3), the stator is a stator of a motor of three phases in which the phase windings are connected by delta connection, in which the winding is divided into a first phase winding, a second phase winding, and a third phase winding corresponding to the three phases, the lead-out portion includes three adjacent slots, the starting end portion and the terminating end portion of the first phase winding are led out from any of two slots on one side in the circumferential direction of the lead-out portion, the starting end portion and the terminating end portion of the second phase winding are led out from any of two slots on another side in the circumferential direction of the lead-out portion, the third phase winding includes the first connecting wire, and the starting end portion and the terminating end portion of the third phase winding are led out from any of two slots on both sides in the circumferential direction of the lead-out portion.
(5) A motor including the stator according to any of (1) to (4), and a rotor that is rotatable around a central axis in a manner opposing the stator in the radial direction.
(6) A drone including the motor according to (5), and a propeller that is fixed to the rotor and is rotatable around a central axis.

As a field of application of the present disclosure, example embodiments of the present disclosure can be used, for example, for motors of drones.

Features of the above-described example embodiments and the modifications thereof may be combined appropriately as long as no conflict arises.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A stator of a motor of multiple phases in which a winding is wound around a stator core, the stator comprising:
an annular core back;
teeth extending in a radial direction from the core back and arranged in a circumferential direction;
a slot between adjacent ones of the teeth; and
a lead-out portion including one or a plurality of adjacent ones of the slots; wherein
the winding is divided into phase windings corresponding to individual phases of the multiple phases;
each of the phase windings includes winding portions wound around one of the teeth, a connecting wire connecting the winding portions, and a starting end portion and a terminating end portion where two terminals of the phase winding are led out;
the starting end portion and the terminating end portion of each of the phase windings are led out from any of the slots of the lead-out portion;
at least one of the phase windings includes:
a first winding portion wound around the one of the teeth farther on one side in the circumferential direction than the lead-out portion;
a second winding portion wound around the one of the teeth farther on another side in the circumferential direction than the lead-out portion; and
a first connecting wire connecting the first winding portion and the second winding portion on one side in an axial direction of the lead-out portion; and
at least a portion of the first connecting wire is on an outer side in the radial direction of at least a portion of the starting end portion and the terminating end portion of each of the phase windings on one side in the axial direction of the lead-out portion.

2. The stator according to claim 1, wherein all of the starting end portions and the terminating end portions of each of the phase windings are led out on an inner side in the radial direction of the first connecting wire.

3. The stator according to claim 1, further comprising N slots, wherein the slot in which the first connecting wire is connected to the second winding portion is an M-th slot toward another side in the circumferential direction from the slot in which the first winding portion is connected to the first connecting wire, and M is N/2 or more.

4. The stator according to claim 1, wherein
the stator is a stator of a motor of three phases in which the phase windings are connected by delta connection;
the winding is divided into a first phase winding, a second phase winding, and a third phase winding corresponding to the three phases;
the lead-out portion includes three adjacent slots;
the starting end portion and the terminating end portion of the first phase winding are led out from any of two slots on one side in the circumferential direction of the lead-out portion;
the starting end portion and the terminating end portion of the second phase winding are led out from any of two slots on another side in the circumferential direction of the lead-out portion;
the third phase winding includes the first connecting wire; and
the starting end portion and the terminating end portion of the third phase winding are led out from any of two slots on both sides in the circumferential direction of the lead-out portion.

5. A motor comprising:
the stator according to claim 1; and
a rotor that is rotatable around a central axis in a manner opposing the stator in the radial direction.

6. A drone comprising:
the motor according to claim 5; and
a propeller that is fixed to the rotor and is rotatable around a central axis.
